(19) United States
(12) Patent Application Publication
(10) Pub. No.: US 2007/0097124 A1
(43) Pub. Date: May 3, 2007

(54) Personalized Chinese character system

(75) Inventors: Ben-Huang Chang, Taipei City (TW); Wen-Bing Horng, Taipei City (TW); Chin-Hwa Kuo, Taipei City (TW)

Correspondence Address: BRUCE H. TROXELL, SUITE 1404, 5205 LEESBURG PIKE, FALLS CHURCH, VA, 22041, US

(73) Assignee: TamKang University

(21) Appl. No.: 11/331,128

(22) Filed: Jan. 13, 2006

(30) Foreign Application Priority Data
Nov. 3, 2005 (TW) 094138555

(51) Int. Cl. G06T 11/00

(52) U.S. Cl. 345/467

(57) ABSTRACT

The present invention relates to a personalized Chinese character system capable of enabling the user to input a personalized Chinese font into a computer. The font can be processed using technologies and saved as a personalized font file. The user can then use the personalized font to create a document or a letter on the computer so that the document or letter would appear as if it were personally handwritten.

### FIELD OF THE INVENTION

The present invention relates to a personalized Chinese character system capable of enabling the user to input a personalized Chinese font into a computer. The font can be processed using technologies, such as the outline method of the true type font, the Bezier curve, etc., then saved as a personalized font file. The user can then use the personalized font to create a document or a letter on the computer so that the document or letter would appear as if it were personally handwritten.

### BACKGROUND OF THE INVENTION

The secret of Chinese characters and its profound cultural values are a precious asset for the Chinese, Chinese characters in a calligraphic form is considered a precious artwork and a cultural treasure around the world. At present, Taiwan is the only country that still uses traditional Chinese characters. It is therefore, naturally, the unspoken responsibility of the Taiwanese to maintain the usage of Chinese calligraphy. Since the age of computers, however, writing with pens in our daily lives has gradually been replaced with typing on the computer. Furthermore technological media has shifted the emphasis in the curriculum of today's basic education away from practicing calligraphy. This calligraphy practicing system integrates the technological media and digital transmission into a haven for teaching, demonstrating, and piquing interest in Chinese calligraphy.

### SUMMARY OF THE INVENTION

The primary objective of the invention is to provide a personalized Chinese character system that enables a user to input a personalized Chinese font into a computer. The font is then processed using specific computer technologies and saved as a personalized font file. The user can use the personalized font to create a document or a letter on the computer so that the document or letter would appear as if it were personally handwritten.

Other aspects and advantages of the present invention will become apparent from the following detailed descriptions, in conjunction with the corresponding drawings, illustrating examples of the principles of the present invention.

### BRIEF DESCRIPTION OF THE DRAWINGS

FIG. 1 is a block diagram showing the structure of the personalized Chinese character system of the present invention.

FIG. 2 is a flow chart showing the operation of the personalized Chinese character system of the present invention.

FIG. 3 is a schematic view of a sample of personalized characters to be processed by the personalized Chinese character system according to a preferred embodiment of the present invention.

FIG. 4 is a schematic view of a digitized character to be processed by the personalized characters according to another preferred embodiment of the present invention.

FIG. 5 is a schematic diagram illustrating the enhancement of the digitized characters of FIG. 4 using the personalized Chinese character system of a preferred embodiment of the present invention.

FIG. 6 is a schematic diagram showing a font formed by performing a curve approximation on the enhanced character made in FIG. 5 according to a preferred embodiment of the present invention.

FIG. 7 is a schematic view of a personalized font file created by a personalized Chinese character system according to a preferred embodiment of the present invention.

### DESCRIPTION OF THE PREFERRED EMBODIMENT

For the esteemed members of the reviewing committee to further understand and recognize the functions and structural characteristics of the invention, several preferable embodiments cooperating with detailed description are presented as the follows.

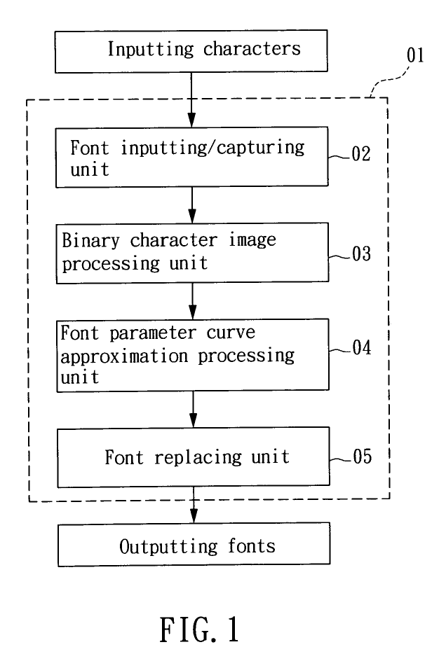

Refer to FIG. 1: The block diagram shows the structure of the personalized Chinese character system of the present invention. The personalized Chinese character system 01 comprises: a character inputting/capturing unit 02, for inputting and capturing a handwritten character made by the user to be converted into a digitized character image file; a binary character image processing unit 03, for optimizing the binary image of the digitized character image file to remove the noise of digitized characters or any remains of excess ink; a font parameter curve approximation processing unit 04, for performing a curve approximation process (e.g. Bezier curves) upon the optimized binary image of the digitized character image file and using the curve control points resulting from the curve approximation process to define a font parameter; a font replacing unit 05, for replacing the inputted character by the defined font parameter to obtain a personalized font.

At present, many fonts designed by font companies are availably selectable by users. However, the most commonly used fonts, such as Regular Script, Ming font, Ancient Font, Seal Character Font, and Imitated Sung Font, etc., are dull and not eye-catching. Therefore, many font companies have ventured to provide various artistic fonts, such as Black Font, Assorted Art Font, Young Girl Font, and POP1 Font, etc., in recent years, but these popularized fonts are still unable to meet the requirements of individuality. Hence, the sole purpose of the personalized Chinese character system of the present invention is to enable a user to input a personalized Chinese font into a computer thereby to be processed and saved as a personalized font file. The invention provides a novel choice for users in the present world because the user could use his or her own personalized font to create a document or a letter on the computer in which the document or letter would appear as if it were personally handwritten.

The True Type Font adopts an outline method for defining a personalized character such as a new True Type Font, in which the edges of the character would first have to be obtained, and then approximated by a Bezier curve while approximately defining the edges according to the file format of the True Type Font. The file is then saved as a True Type Font file. Thereby, the newly defined True Type Font of the personalized character can be used by a word processing software such as the Microsoft Word for typesetting.

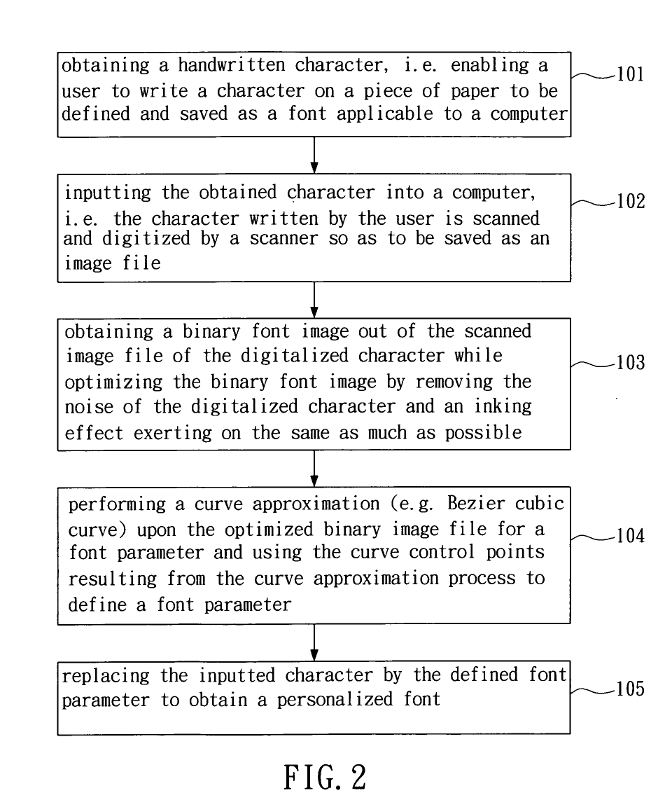

Refer to FIG. 2: The flow chart shows the operation of the personalized Chinese character system of the present invention. In FIG. 2, the flow chart comprises the following steps:

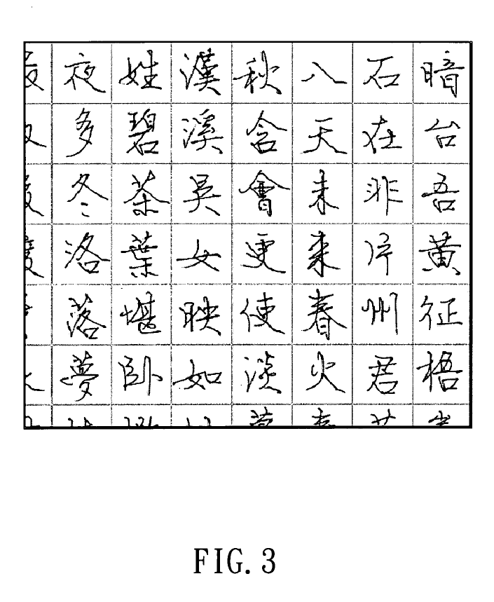

step 101: obtaining a handwritten character, i.e. enabling a user to write a word character on a piece of paper that will later be defined and saved as a font file compatible with a computer, such as those shown in FIG. 3.

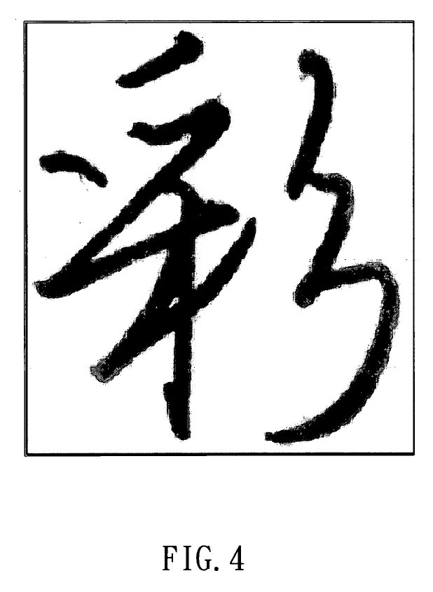

step 102: inputting the obtained character into a computer, i.e. the character written by the user is scanned and digitized by a scanner and saved as an image file, such as the character shown in FIG. 4.

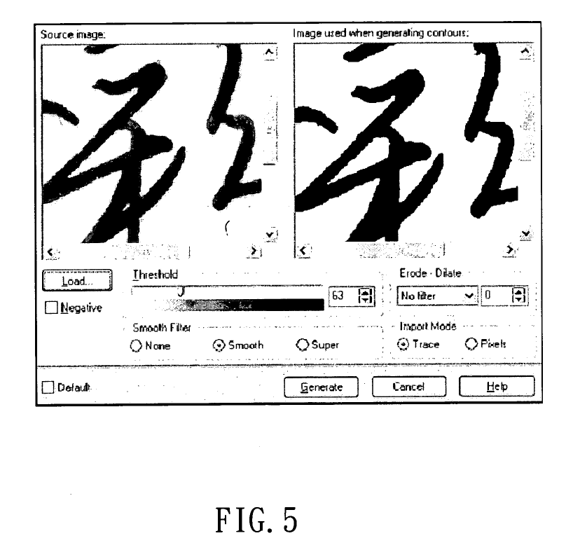

step 103: obtaining a binary font image out of the digitized character's scanned image file while optimizing the binary font image by removing the noise of the digitized character and remains of excess ink by exerting on the same as much as possible as shown in FIG. 5.

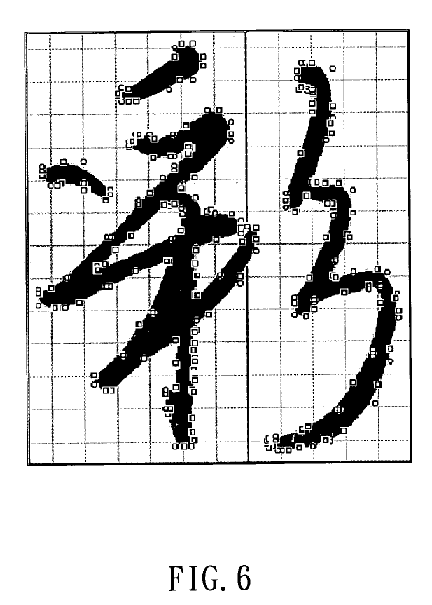

step 104: performing a curve approximation (e.g. Bezier curves) upon the optimized binary image file for a font parameter and using the curve control points resulting from the curve approximation process to define a font parameter as shown in FIG. 6.

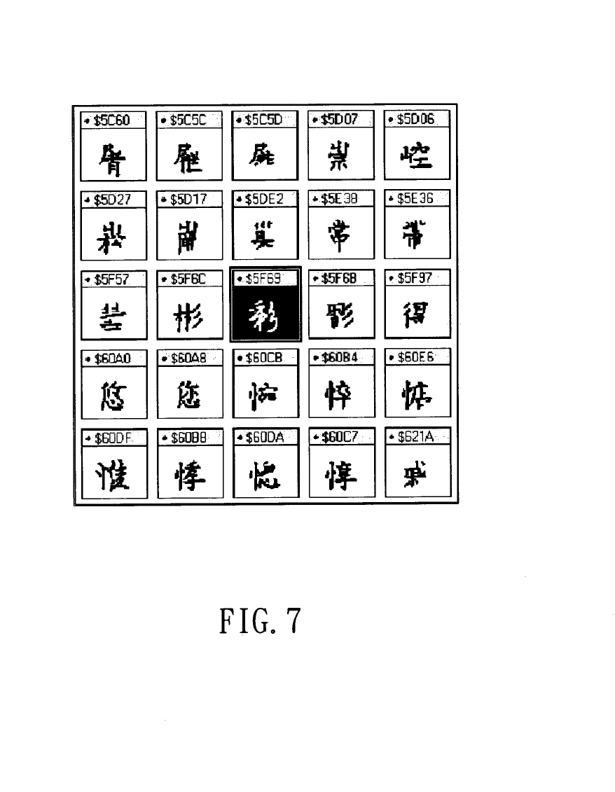

step 105: replacing the inputted character with the defined font parameter to obtain a personalized font as shown in FIG. 7.

The handwritten character can be obtained and inputted into a computer by the character inputting/capturing unit 02 of the personalized Chinese character system 01 shown in FIG. 1. In the preferred embodiment of the invention, obtaining a handwritten character and inputting the character into a computer, shown in the step 101 and step 102 of FIG. 2, can be integrated into a single step in which inputting the character into the computer is done using the digital writing pad. The trouble of writing on a piece of paper and then scanning the paper is thus avoided, saving both time and labor.

In summary of the description above, the personalized Chinese character system of the present invention utilizes artificial intelligence, expert system, image processing, computer graphics, and mode identification technologies to input personalized characters into a computer to create a personalized font file which can be used for writing a letter or a document just like a handwritten letter or document. In today's world of computers, the invention has enhances innovation and creativity because users can create their own personalized fonts and put them to use in a word processor.

While the preferred embodiment of the invention has been set forth for the purpose of disclosure, modifications of the disclosed embodiment of the invention as well as other embodiments thereof may occur to those skilled in the art. Accordingly, the appended claims are intended to cover all the embodiments which do not depart from the spirit and scope of the invention.

What is claimed is:

1. A personalized Chinese character system, comprising:
(a) a character inputting/capturing unit, for inputting and capturing a handwritten character of a user to be converted into a digitized character image file;
(b) a binary character image processing unit, for optimizing the binary image of the digitized character image file to remove the noise of digitized character or any remains of excess ink;
(c) a font parameter curve approximation processing unit, for performing a curve approximation process upon the optimized binary image of the digitized character image file and using the curve control points resulting from the curve approximation process to define a font parameter; and
(d) a font replacing unit, for replacing the inputted character by the defined font parameter to obtain a personalized font.

2. The system of claim 1, wherein said character inputting/capturing unit is a scanner.

3. The system of claim 1, wherein said character inputting/capturing unit is a digital notepad.

4. The system of claim 1, wherein said curve approximation process is a process of Bezier curve approximation.

5. A method of implementing a personalized Chinese character system, comprising the steps of:
(a) enabling a user to write the character on a character inputting/capturing unit connected to a computer, allowing the written character to be digitized and inputted into the computer, and then saved as an image file. The file will later be defined as a font applicable to the computer;
(b) obtaining a binary font image out of the image file of the digitized character while optimizing the binary font image by removing the noise of the digitized character and remains of excess ink exerting on the same;
(c) performing a curve approximation upon the optimized binary image file for a font parameter and using the curve control points resulting from the curve approximation process to define a font parameter; and
(d) replacing the inputted character with the defined font parameter to obtain a personalized font.

6. The method of claim 5, wherein said character inputting/capturing unit is a scanner.

7. The method of claim 5, wherein said character inputting/capturing unit is a digital notepad.

8. The method of claim 5, wherein said curve approximation process is a process in the Bezier curve approximation.

9. A method of implementing a personalized Chinese character system, comprising the steps of:
(a) enabling a user to write the character, later defined as a font applicable to a computer, on a piece of paper;
(b)using a character inputting/capturing unit to digitize the character and save the digitized character as an image file;
(c) obtaining a binary font image out of the image file of the digitized character while optimizing the binary font image by removing the noise of the digitized character and remains of excess ink;
(d)performing a curve approximation upon the optimized binary image file for to obtain curve control points, and then using the curve control points resulting from the curve approximation process to define the font parameter; and
(e) replacing the inputted character with the defined font parameter to obtain a personalized font.

10. The method of claim 9, wherein said character inputting/capturing unit is a scanner.

11. The method of claim 9, wherein said character inputting/capturing unit is a digital notepad.

12. The method of claim 9, wherein said curve approximation process is a process in the Bezier curve approximation.
